(19) United States
(12) Patent Application Publication
(10) Pub. No.: US 2011/0106336 A1
(43) Pub. Date: May 5, 2011

(54) Vehicle Utility Communication System

(75) Inventors: Jostein Eikeland, Boca Raton, FL (US); Stein Christiansen, Parkland, FL (US); Christopher Christiansen, Parkland, FL (US)

(73) Assignee: Alevo, Inc., Boca Raton, FL (US)

(21) Appl. No.: 12/768,406

(22) Filed: Apr. 27, 2010

Related U.S. Application Data
(60) Provisional application No. 61/174,329, filed on Apr. 30, 2009.

(51) Int. Cl. G06F 7/00; H02J 7/00; G08C 19/16; H04W 64/00; H04N 7/18; G06Q 30/00

(52) U.S. Cl. 701/2; 320/107; 320/109; 320/112; 340/12.32; 455/456.1; 348/148; 705/34

(57) ABSTRACT

A charger configured to charge at least one battery used in transportation means or stationary equipment, includes a plurality of power connections configured to couple to a plurality of power sources. The charger is adapted to receive power from the plurality of power sources simultaneously.

### CROSS-REFERENCE TO RELATED APPLICATIONS

This application claims the benefit of U.S. Provisional Application No. 61/174,329, filed Apr. 30, 2009, which is incorporated herein by reference in its entirety for all purposes.

### TECHNOLOGICAL BACKGROUND

The present disclosure is directed to a vehicle to grid infrastructure and, more particularly, to a vehicle communications system that requires minimal to no upgrades to the existing electrical grid system.

The growing need to reduce air pollutants and the dependence on oil as an energy source has triggered the development of hybrid and battery electric vehicles. Energy storage and electric propulsion theories and technologies are in constant progress to facilitate the new infrastructure demanded to realize this development.

To facilitate the increased need for energy to charge hybrid and battery electric vehicles, a more efficient infrastructure is needed which preferably does not require an upgrade to today's grid system that includes approximately 200,000 miles of power lines, much of which has been in use for more than 50 years.

### SUMMARY

Hybrid and battery electric vehicles and commercial vehicles may have the capability to carry a battery capacity varying from 1 kWh to over 100 kWh. This capacity can be used to balance an overloaded grid and supply local spinning reserves and regulation. Regulation is the process of stabilizing the grid. During peak periods, certain locations need extra energy and the utility company has to increase production or engage backup generators (spinning reserves) to address the need. Vehicle to grid can supply local regulation. For example, if 10 households need additional energy during the morning hours, a vehicle in the local grid can accommodate that need. By doing so, the grid does not have peaks and the energy losses are much lower than conventional ways of transferring energy across the grid.

Communication within the grid is critical during vehicle to grid connection. An investment of 1.2-1.5 trillion USD has been deemed necessary to upgrade the grid to facilitate vehicle to grid in its current form.

Vehicle charge points have to be flexible and not purely limited to a residence or workplace. Charge points dependent on smart cards and online accounts may be developed, but are costly to deploy. Also, all electric and hybrid vehicles require an infrastructure that makes flexible charging possible at a minimum investment.

One aspect of the present disclosure is directed to a charger in a hybrid or battery electric vehicle configured to connect to multiple power sources to enable simultaneous charging of one or more rechargeable batteries. The charger can accept any one or combination of available power sources, such as 110V, 220V and 400V inputs and it has a plurality of charger modules each of which is connected to a charger management unit. Each of the charger modules may have a separate AC/DC converter, or they may share one converter. The charger can be configured to provide charge to multiple charger modules simultaneously. This configuration increases efficiency as each charger module may charge the battery packs coupled to it independent of the other charger modules.

In order to supply the grid with energy, the charger is capable of bi-directional energy flow. The charger management unit may be configured to set the energy flow direction (regulation up or down) when the charger is connected to the power grid and in response to an external command (e.g., from the utility company or the vehicle user). The charger management unit may also set the energy flow based on a plurality of factors such as battery packs' state of health (SoH) and battery packs' state of charge (SoC). Due to increased heat from high voltage charging, advanced heat dissipation technology is use as a component of the charger.

Another aspect of the present disclosure is directed to two methods of recognizing the location of a vehicle without the need for grid upgrades. The vehicle transmits a signal into the grid in a wired fashion and simultaneously transmits a wireless signal through the GPS/GSM/Radio telemetric system. The first method may use a signal processor in a vehicle's charger that monitors the utility companies' supervisory protocol and generates a series of binary pulses and sends it through the socket into the grid (i.e., in a wired fashion). The pulse can be detected by the utility companies to locate and confirm the presence of the vehicle. To the extent that utility companies are capable of monitoring and identifying equipment and appliances in a building via individual sockets within the building, no upgrade the power grid using this technique would be needed. The energy for this pulse may be supplied by a capacitor in the charger or by the battery.

The second method involves using a telemetric unit that utilizes GPS/GSM and radio signals. The location of the vehicle can be independently determined with each of GPS, GSM and radio and the results can be compared to one another to more accurately pin-point the location of the vehicle. In locations where GPS is not available (e.g., in tunnels or underground parking structures), GSM and Radio can be used to determine the location of the vehicle. A WAAS (Wide Area Augmentation System) chip may also be used in the telemetric unit to achieve even greater accuracy in locating the vehicle.

Another aspect of the present disclosure is directed to use of the telemetric unit to transfer data such as the location of the vehicle along with other parameters such as state of the battery and billing information to the utility company via a third party service operator. The telemetric unit records and transfers information such as state of the battery, level of charge, location of vehicle and information about the owner of the vehicle to a third party. All this information may be used by: (1) the third party to process the billing transaction (i.e., bill the vehicle owner's account in case of taking charge from the grid or credit the owner's account in case of providing charge to the grid), and (2) the utility company to determine the availability of a vehicle for regulation up or down. Utilizing this system, the vehicle can be connected to the power grid anywhere and the billing transaction can be handled at that location in real time.

In another aspect of the present disclosure, the signal processor in the charger is configured to communicate with the telemetric unit and send information such as state of the charge and state of the health of the battery to the utility company via sequences of binary pulses.

Another aspect of the present disclosure is directed to a safety protocol for immediate shut down of flow of charge between the charger and the grid via a low frequency shut off command sent by a third party or the utility company that operates in a frequency band that ensures the delivery of the shut down command.

Yet another aspect of the present disclosure is directed to a surveillance system that include video cameras coupled to the telemetric unit, to capture video from the inside and/or outside perimeter of the vehicle. The telemetric unit is configured to archive the captured video for a predetermined amount of time and to wirelessly transmit the video to a third party automatically or upon request.

The following detailed description and the accompanying drawings provide a better understanding of the nature and advantages of the present invention.

### BRIEF DESCRIPTION OF THE DRAWINGS

FIG. 1 is diagrammatic and schematic illustration of an exemplary vehicle communication system according to an embodiment of the invention;

FIG. 2 is a schematic illustration of the internal system in the vehicle illustrated in FIG. 1, in accordance with an embodiment of the invention;

FIG. 3 is a more detailed schematic illustration of battery charger 144 in FIG. 1, in accordance with an embodiment of the invention;

FIG. 4 is a schematic illustration of the telemetric unit demonstrated as part of the vehicle communication system, in accordance with an embodiment of the invention;

FIG. 5 is a schematic illustration of the information transaction illustrated in FIG. 1, in accordance with an embodiment of the invention;

FIG. 6 is a schematic illustrating the sequence of events initiated upon plugging a vehicle into the grid, in accordance with an embodiment of the invention;

FIG. 7 is an illustration of the energy flow within the batter charger illustrated in FIG. 1, in accordance with an embodiment of the invention;

FIG. 8 is a sequential illustration of the low frequency shut off command illustrated in FIG. 1, in accordance with an embodiment of the invention;

FIG. 9 is a sequential illustration of the pulse illustrated in FIG. 1.

FIG. 10 is an illustration of the signal interaction within the telemetric unit illustrated in FIG. 1, in accordance with an embodiment of the invention;

FIG. 11 is an illustration of charging utilizing multiple plugs, in accordance with an embodiment of the invention; and

FIG. 12 is an illustration of the cameras connection to the telemetric unit and black box, in accordance with an embodiment of the invention.

### DETAILED DESCRIPTION OF THE INVENTION

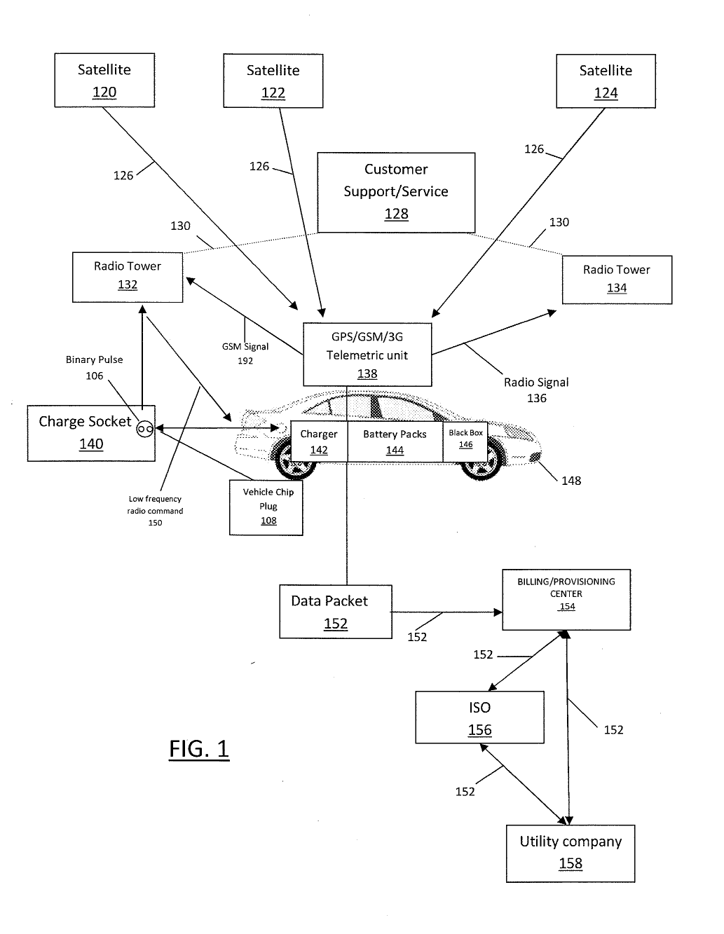

FIG. 1 illustrates an example of a vehicle plugged into the grid utilizing the vehicle communication system according to an embodiment of the invention. Vehicle 148 may be a hybrid or battery electric vehicle having available battery storage and plug in capabilities. Vehicle batteries 144 may be any type of rechargeable battery.

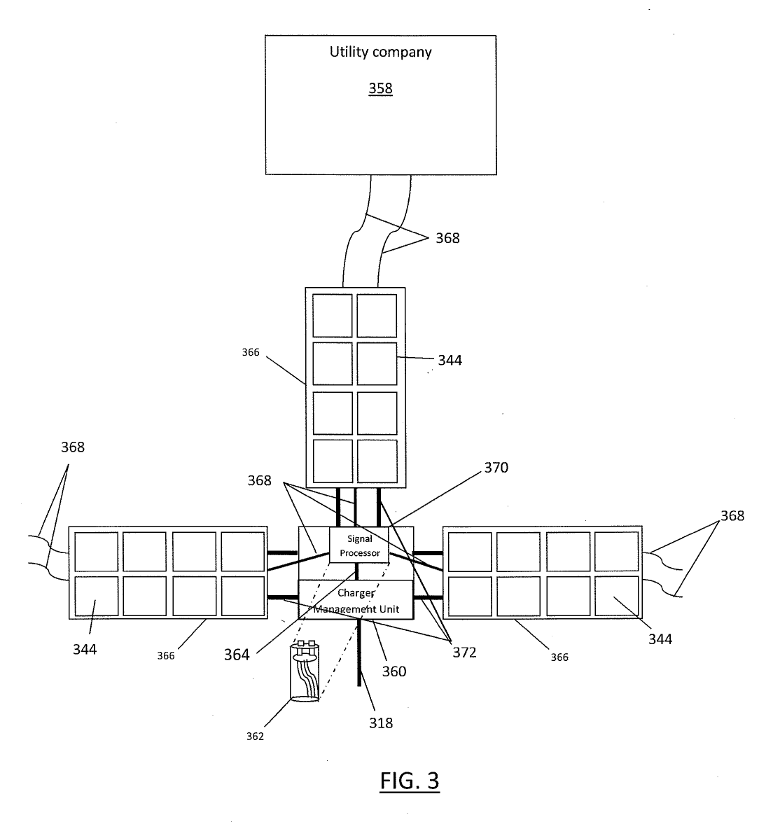

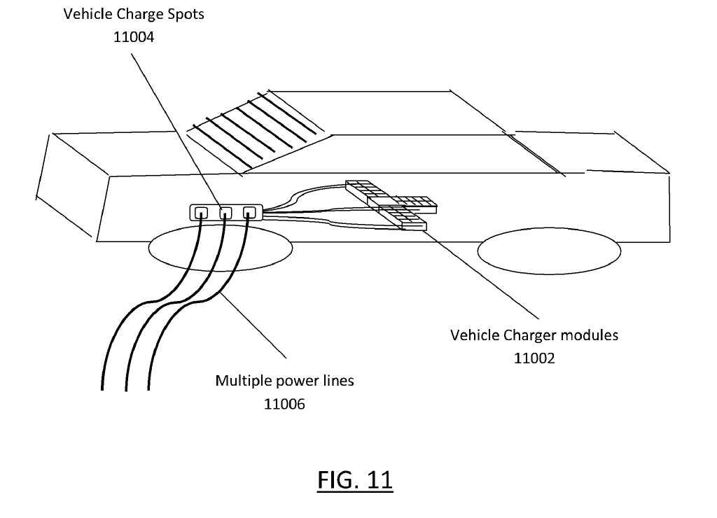

Charger 142 may be configured to accept any one or a combination of available power sources, such as 110V, 220V and 400V inputs. Charger 142 may be modular, with each charger module 366 (FIG. 3) independently connected through the modular connection 372 to charger management unit 360. Charger management unit 360 may in turn be connected to a telemetric unit (not shown in FIG. 3) via connection 318. Each charger module 366 may have an AC/DC converter, or two or more of charger modules may share one converter. Due to increased heat from high voltage charging, charger 142 may have a magnesium casing with heat dissipation capabilities. For example, upon plugging in to a charge socket, vehicle 148 may plug into multiple 110V, 220V outlets. By allowing multiple plugs to connect simultaneously, charger 142 may double or triple the line capacity thereby reducing charge times significantly. By engaging multiple charger modules 366 (FIG. 3), the charger may increase efficiency as each charger module 366 may individually charge attached battery packs 344. Management Unit 360 may determine available battery and line capacity to adjust charge algorithm. As illustrated in FIG. 11, charger 11002 may be able to accept multiple connections simultaneously. Multiple power lines 11006 may be connected to charger modules 110002 via vehicle charge spots 110004. Based upon available line capacity, management unit 360 (FIG. 3) may establish how many modules should accept energy input or provide energy output.

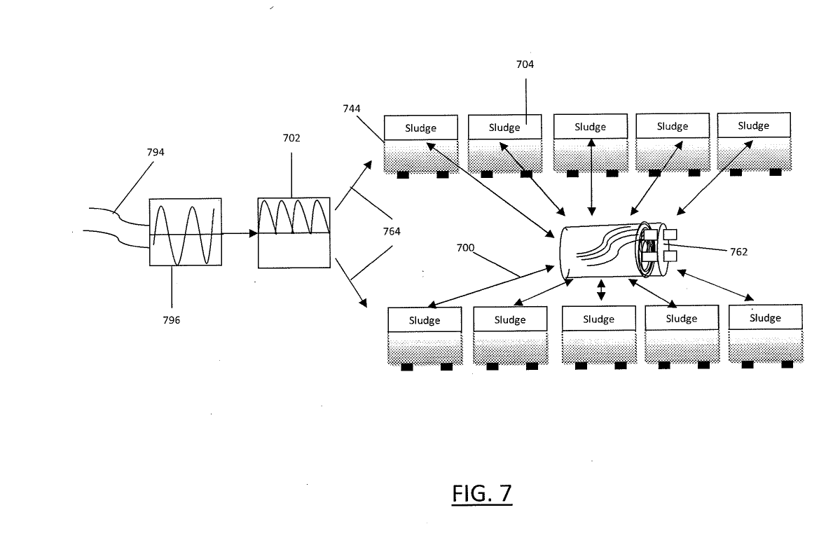

In FIG. 1, Charger 142 may be designed for inorganic electrolyte batteries. Each charger module 366 (FIG. 3) may accept energy input from multiple power sources (e.g., one or more of 110V, 220V or 400V power sources 794 (FIG. 7)). AC power 796 may be converted through a full wave rectifier to high energy DC power 702 which may in turn be used to charge each battery pack 744 rapidly to 50-55% of battery capacity. After 55%, battery packs 744 may develop sludge 704 in the battery electrolyte due to fast charging. In order to complete the charge process, stored sludge energy may be drawn (as depicted by reference numeral 700) from battery packs 744 into a capacitor 762. Capacitor 762 may redistribute the sludge energy to battery packs 744. As an additional safety feature, charger 142 may have a SO2 capture system. In case of battery short circuit, SO2 gas may leak from battery packs 744. Capture system may capture the SO2 gas in a sealed enclosure or an absorbent material. Based upon a low energy connection, battery sludge 704 may not be a factor and regular charging may commence as the electrolyte may remain stable.

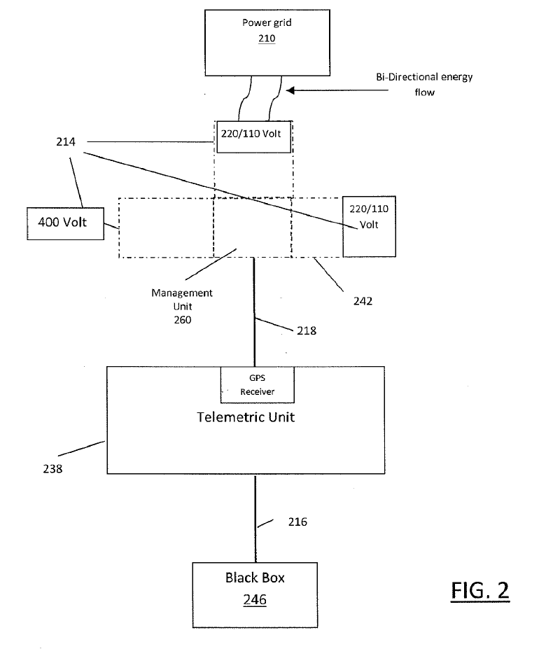

FIG. 2 illustrates an exemplary connection between charger 242 and telemetric unit 238. Charger 242 is configured to receive one or a combination of available power sources. FIG. 2 shows 110V/220V/400V as possible power sources, but charger may be adapted to receive power sources with different voltage levels than those shown in FIG. 2. Charger management unit 260 may be arranged as the main connection with telemetric unit 238. Charger 242 may communicate with telemetric unit 238 information about the battery State of Health (SoH) through charger management unit 260. Management Unit 260 may be configured to set the direction of the energy flow. Based upon battery State of Health and battery State of Charge (SoC), management unit 260 may initiate either regulation up (supply) or regulation down (charging). FIG. 2 also illustrates the communication between telemetric unit 238, charger management unit 260 and power grid 210. While plugged into the power grid, any hybrid or battery electric vehicle 148 (FIG. 1) may charge the batteries or supply power grid 210 through charger 242. That is, charger 242 may be configured to receive energy from or supply energy to grid 210. For example, battery packs may have available capacity of 35 kWh. Telemetric unit 238 may be remotely instructed by utility company 158 (FIG. 1) to initiate supplying energy to the grid via a charge socket modified to enable energy supply power grid 210. Grid upgrades are not needed, however installing a grid control switch at the dedicated supply socket's fuse box may be needed for regulation up. Information, such as, battery status, plug location and general vehicle diagnostics, or any other suitable information, may be conveyed between charger management unit 260 and the onboard telemetric unit 238. This information may be transferred through the telemetric unit's input/output (I/O) channels. In one embodiment, telemetric unit 242 has 32 I/O channels.

In one embodiment, there are two separate communication channels between the vehicle and utility Company 358 (FIG. 3). The initial communication occurs when a vehicle is plugged into the grid. In order for utility company 358 to locate the exact location of the plugged-in vehicle, the vehicle may respond to the utility company's monitoring and supervisory protocols. As often as 60 times a second to every 6th second, the utility company may send out a monitory signal on to the grid. Signal processor 370 (FIG. 3) may be passive and may be activated to respond upon receiving a known signal protocol from the utility company transmitted through the grid. By configuring signal processor 370 to read and respond to the signal protocols (a communication process that is currently in use by utility companies to communicate with their substations over the grid), the utility company may detect the location of the vehicle. Signal processor 370 may be updated to allow for different monitoring protocols through the onboard telemetric unit 238 (FIG. 2). Upon acknowledgment, signal processor 370 may respond by relaying a binary pulse 106 (FIG. 1) in to the grid. Pulse 368 may draw energy from capacitor 362 located within the charger, or from vehicle batteries 344.

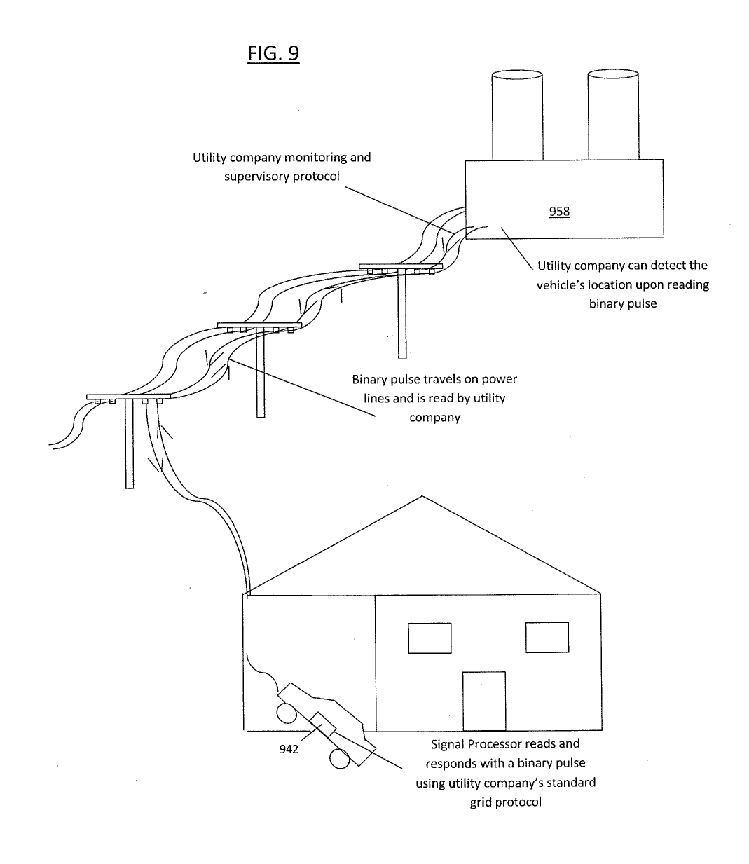

As illustrated in FIG. 9, upon connection to the grid, signal processor 370 (FIG. 3) may read the monitoring protocol initiated by utility company 958. Upon reading the protocol, signal processor 370 may respond with a series of pulses into the grid through a socket. Pulse 368 (FIG. 3) may be compatible with utility standards such as SCADA (supervisory control and data acquisition), IEEE Synchrophaser C37.118, IEC60870, and IEC 61850 (communication networks and systems in substations). Pulse 368 travels on the power lines and utility company 958 may read and detect the vehicle's location, charge capacity and identify the owner of the vehicle. Pulse 368 (FIG. 3) may be utilized in conjunction with the telemetric unit to ensure the redundancy of the communication process. Power line communication may be used for identifying the exact charge socket and used in case of arbitrary situations. Exact charge location may be important to ensure that the correct responsible party is billed and that the utility company 358 has precise real time information in order to balance the grid. Local regulation may be of significant importance in order to achieve a balanced grid.

The utility company may communicate with the vehicle during utility company's standard grid surveillance procedure initiated as often as 60 times a second up to every 6th second. The utility company may record time and date according to Coordinated Universal Time (UTC). Upon the end of the charge/discharge sequence, signal processor 370 may send out another pulse and utility company 358 may record the time and date and measure the charge/discharge sequence.

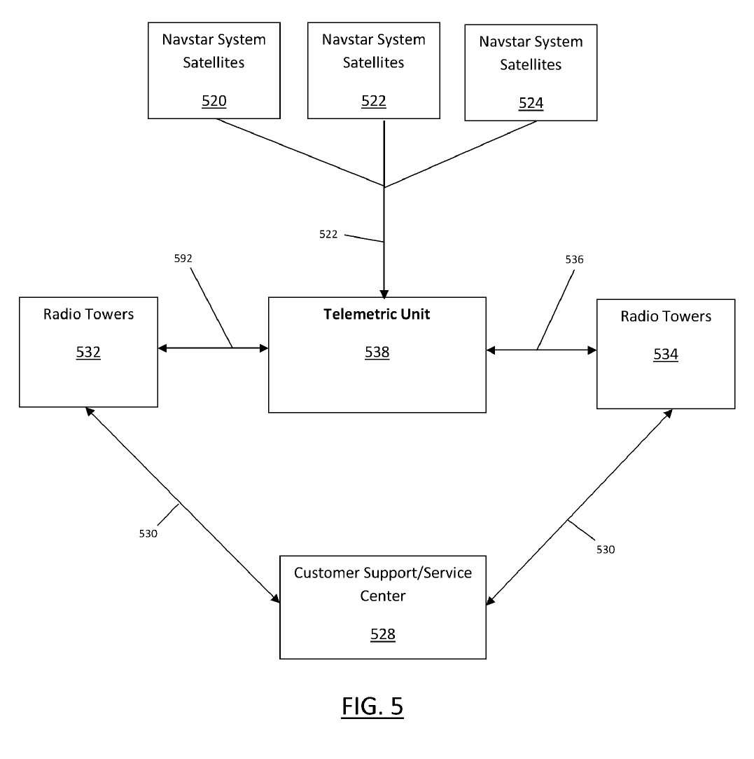

The second and primary communication channel between utility company 158 and vehicle 148 is telemetric unit 138 (FIG. 1). Telemetric unit 138 may triangulate the vehicle's exact position within one cubic foot through Navstar Global Positioning System (GPS) Satellites 520, 522, 524 (FIG. 5) corresponding to satellites 120, 122 and 124 of FIG. 1, Global System for Mobile communication (GSM) networks 192 (FIG. 1) and Radio signals 136. GSM 192 and Radio signal 136 are configured so that vehicle 148 may triangulate its position in locations where GPS satellite signals are unavailable, such as parking structures and underground tunnels.

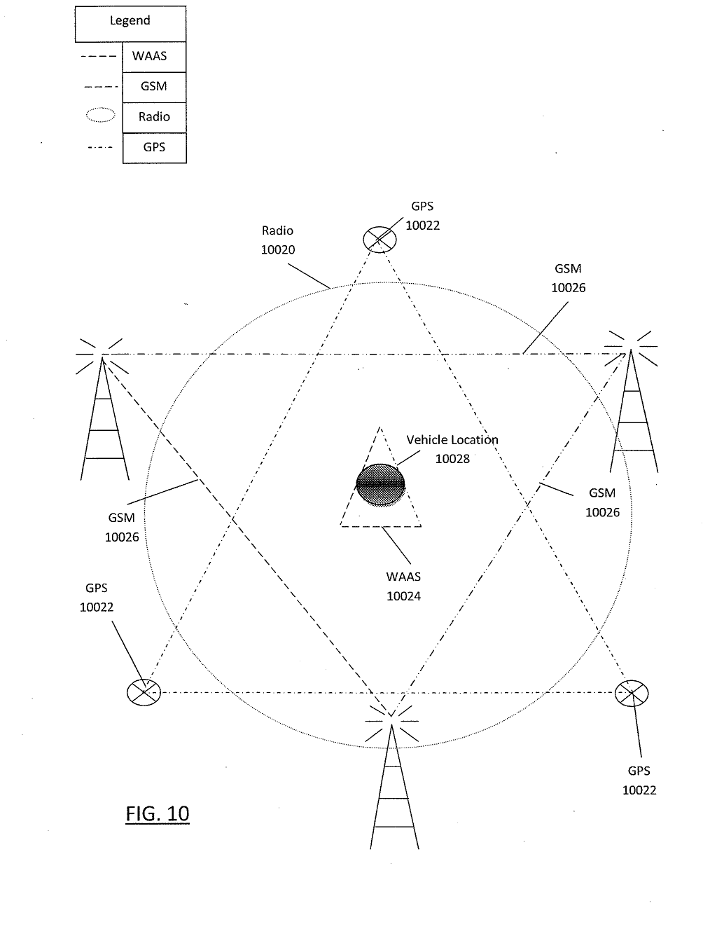

FIG. 10 illustrates how telemetric unit 138 may pinpoint the vehicle's exact location. GPS 10022 in combination with Wide Area Augmentation System (WAAS) 10024 may triangulate the vehicles location 10028 within one cubic foot. By adding in both radio and GSM signals, vehicle's location 10028 may be pinpointed with greater accuracy. Radio Signal 136 may operate in the FM commercial broad cast, Very High Frequency (VHF) band, Ultra High Frequency (UHF) band and the 900 MHz bands. Telemetric unit 138 may support common radio communication protocols including POCSAG, ERMES, TAP, FLEX, reFLEX, GOLAY and NTT.

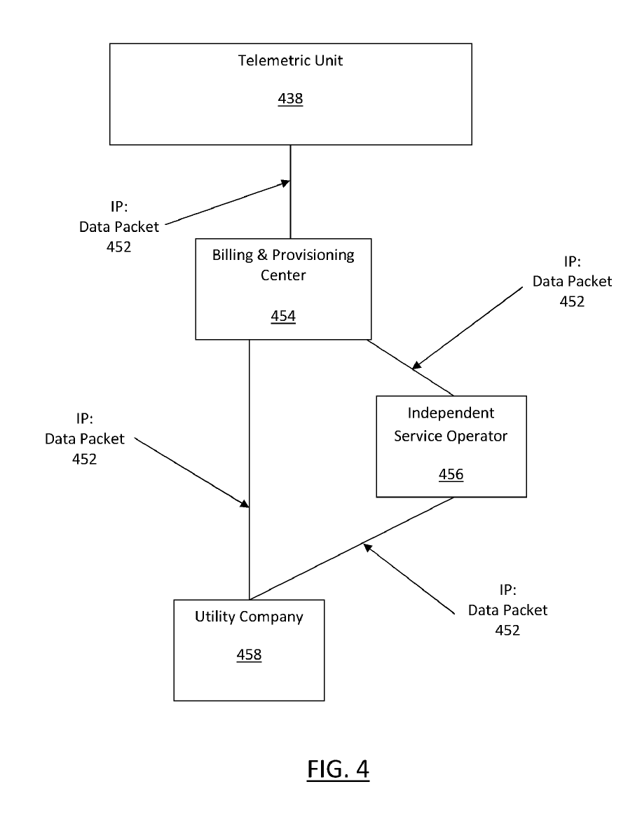

Telemetric unit 138 may record the exact position when a vehicle is plugged into the grid, capacity charged or discharged, vehicle status and diagnostics. Vehicle plug chip 108 may triangulate the plugs' exact position through the Wide Area Augmentation System (WAAS) chip. The chip may enable locating the plug's exact position through WAAS reference stations. Combination of GPS, WAAS, Radio and GSM may allow vehicle 148 to have its exact position recorded at all times. Telemetric unit 438 (FIG. 4) may transfer data packet 452 to billing and provisioning center 454 over Internet Protocol (IP) on a set schedule. Billing and provisioning center 454 may evaluate and decode the data and forward the information through Independent Service Operator (ISO) 456 or directly to utility company 458. Utility company 458 may identify the customer, charge socket used, and credit the customer for regulation up or charge for regulation down (charging). Secondly, the utility company 458 may debit the socket owner that was initially charged and credit the vehicle owner in those cases where the socket owner and vehicle owner are different.

An ISO is an organization typically formed at the direction or recommendation of the Federal Energy Regulatory Commission (FERC). In the areas where an ISO is established, it typically coordinates, controls, and monitors the operation of the electrical power system, usually within a single US State, but sometimes encompassing multiple states. An ISO is usually an impartial link between power plants and the utilities that serve the consumers.

In case of an emergency in the grid, such as power line maintenance or outages, charger management unit 360 (FIG. 3) may accept a low frequency radio shut off command 150 (FIG. 1) from the governing utility company or the ISO. During regulation up (vehicle supplying the grid), it is critical that the governing utility company has the ability to shut off regulation remotely to avoid injury to workers or customers in the vicinity of an exposed power line. Radio command 150 may be transmitted through Single Sideband Radio, in 4000 KHz and 8100 KHz frequencies. Low frequency may be used to ensure that command 150 is delivered in locations where high frequency can not be transmitted to. Command 150 may immediately shut down regulation up through the emergency shut off in charger management unit 360 (FIG. 3).

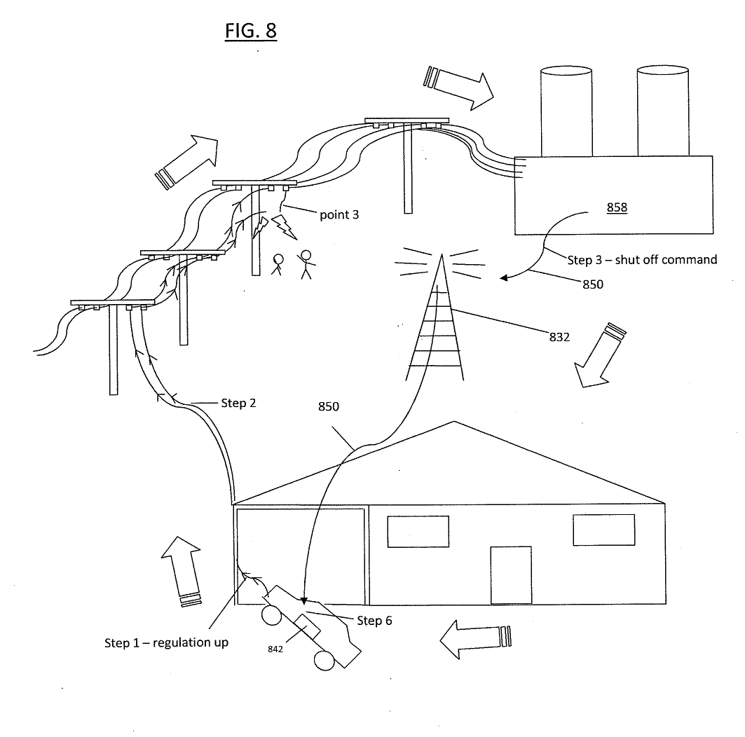

This is more clearly illustrated in FIG. 8. Upon connection to the grid, the vehicle may initiate regulation up as illustrated in step 1. Step 2 illustrates the energy flow from the vehicle to the grid and the energy traveling along the grid. At point 3, the power grid has a downed line. As illustrated by step 3, upon recognizing the downed line, utility company 858 may immediately send out an emergency shut off command 850 through radio towers 832. Upon receiving the shut off command, charger 842 may immediately terminate regulation up and stop the energy supply into to the grid.

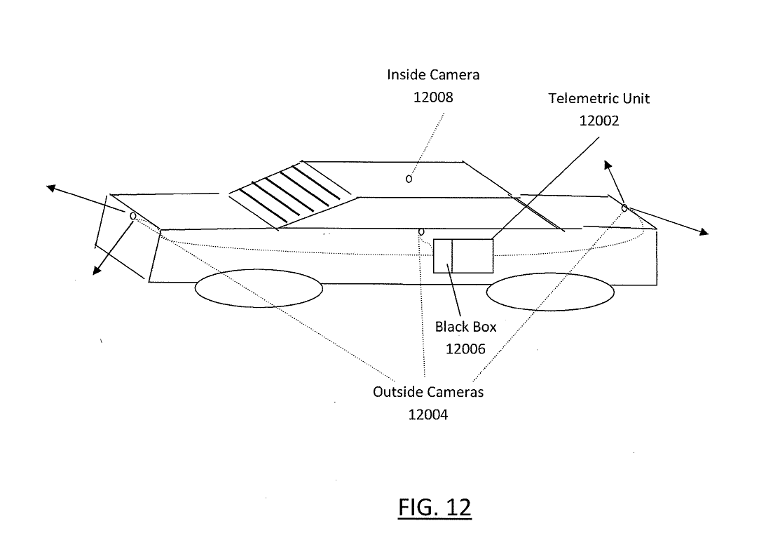

Customer support/service center 128 (FIG. 1) may be set up as a twenty four hour customer support center that offers two way communication through telemetric unit 138 through GSM and Internet Protocol, such as voice (VoIP), email and SMS. Telemetric unit 138 may be configured to record and transmit video. Video may be recorded and used in case of charge location disputes and may also be an important tool in accident and security investigations. Video may be streaming and accessed online through a third party web portal or through recordings in the vehicle's black box 146. Video may be recorded from a 360 degree angle outside or inside the vehicle. As illustrated in FIG. 12, telemetric unit 12002 and black box 12006 may be connected with the vehicle's outside cameras 12004 or inside cameras 12008. Cameras inside the vehicle may be activated in case of vehicle theft or suspicion of fraudulent usage. Cameras outside the vehicle may be used to identify charge location and obtain footage of an accident. Video may be streamed from the vehicle to a third party portal using the ADACTUS protocol. ADACTUS may enable the vehicle to transmit live high definition video through multiple channels. Black box 146 located in telemetric unit 138 may store up to 72 hours of diagnostic data and video which can be physically accessed through the black box's hard drive.

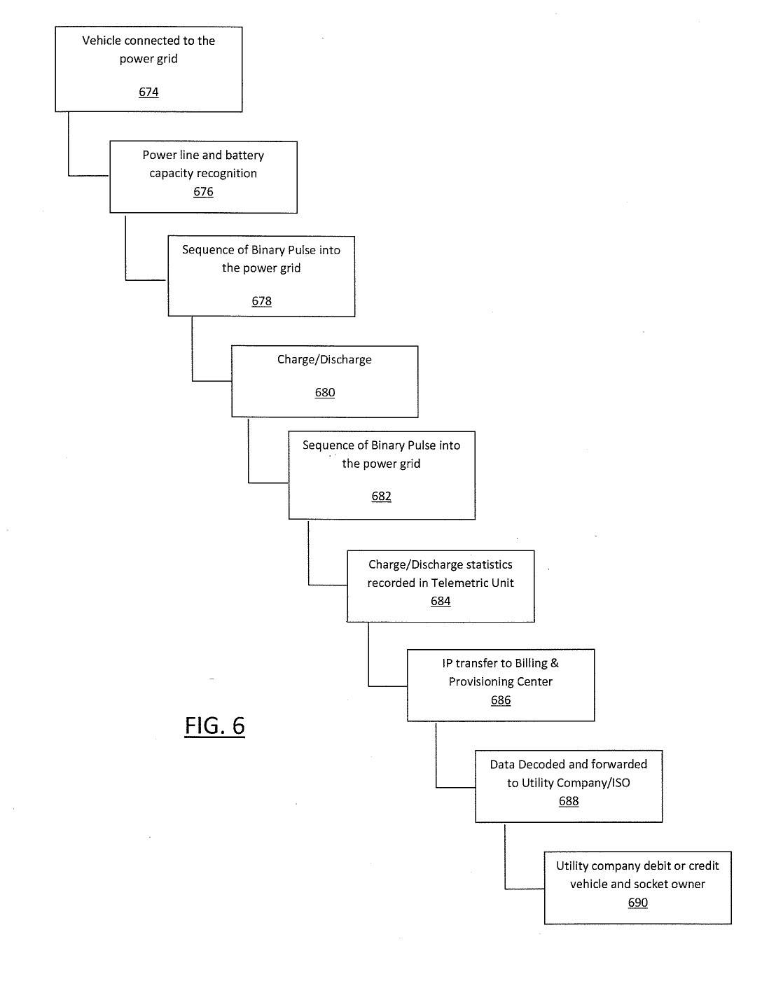

FIG. 6 illustrates the sequence of events starting with the vehicle connecting to the power grid as illustrated by step 674. Upon connection, charger management unit 360 (FIG. 3) may recognize battery and power line capacity (step 676). Signal processor 370 (FIG. 3) may transmit the sequence of binary pulse into the grid (step 678). Charger 242 (FIG. 2) may either draw power from the power grid or provide charge to the grid (step 680). Upon disconnecting from the grid, signal processor 360 (FIG. 3) may send a sequence of binary pulses (step 682). The load statistics is recorded in the telemetric unit (step 684). Pending upload schedule, the telemetric unit may transfer the data to the billing and provisioning center 454 (step 686). Billing and provisioning center 454 decodes the charge/discharge statistics and may forward the data to the utility company or the ISO (step 688). The utility company 458 receives the information and may credit or debit the appropriate vehicle and/or socket owner (step 690).

While the above description and the accompanying figures provide various embodiments, the invention is not limited only to the disclosed embodiments. For example, while most embodiments are described in the context of a vehicle such as a car, the various embodiments of the invention may be implemented in any transportation means or moving object that could benefit from use of rechargeable batteries, such as buses, trains, planes, ships, and motorcycles.

What is claimed is:

1. A charger configured to charge at least one battery used in transportation means or stationary equipment, comprising:
a plurality of power connections configured to couple to a plurality of power sources, wherein the charger is adapted to receive power from the plurality of power sources simultaneously.

2. The charger of claim 1, further comprising:
a plurality of charger modules each configured to couple to one or more battery packs.

3. The charger of claim 2, further comprising:
a plurality of power converters each coupled to one of the modules and adapted to independently receive power from one or more of the power sources and supply direct current to the corresponding charger module.

4. The charger of claim 2, further comprising:
a charger management unit coupled to the plurality of charger modules wherein depending on level of charge in the battery packs coupled to each charger module and the power capacity of each of the power sources, the charger management unit determines which of the charger modules receives or supplies charge.

5. The charger of claim 4, wherein the charger management unit is configured to provide regulation up or down when the charger is connected to a power grid.

6. The charger of claim 2, further comprising:
a charger management unit coupled to the plurality of charger modules, and configured to monitor each of the battery packs coupled to the charger modules, wherein the charger management unit controls the flow of power to the battery packs.

7. The charger of claim 2, further comprising:
a charger management unit coupled to the plurality of charger modules, and configured to monitor each of the battery packs coupled to the charger modules; and
at least one capacitor coupled to the charger, wherein the charger management unit is configured to transfer sludge energy from each of the battery packs to the capacitor during charging process.

8. The charger of claim 1, wherein the multiple power sources can supply the same or different voltage levels.

9. A charger configured to charge at least a battery used in a transportation means or stationary equipment, comprising:
a plurality of charger modules each configured to couple to one or more battery packs.

10. The charger of claim 9 further comprising:
a plurality of power connections configured to couple to a plurality of power sources, wherein the charger is adapted to receive power from the plurality of power sources simultaneously.

11. The charger of claim 9, further comprising:
a plurality of power converters each coupled to one of the charger modules and adapted to independently receive power from one or more of the power sources and supply direct current to the corresponding charger module.

12. The charger of claim 9, further comprising:
a charger management unit coupled to the plurality of charger modules wherein depending on the level of charge in the battery packs in each charger module and the power capacity of each of the power sources, the charger management unit determines which charger modules receive or supply charge.

13. The charger of claim 12, wherein the charger management unit is configured to regulate up or down.

14. The charger of claim 9, further comprising:
a charger management unit coupled to the plurality of charger modules, and configured to monitor each of the battery packs coupled to the charger modules, wherein the charger management unit controls the flow of power to the battery packs.

15. The charger of claim 9, further comprising:
a charger management unit coupled to the plurality of charger modules, and configured to monitor each of the battery packs coupled to the charger modules; and
at least one capacitor coupled to the charger, wherein the charger management unit is configured to transfer sludge energy from each of the battery packs to the capacitor during charging process.

16. The charger of claim 10, wherein the multiple power sources can supply the same or different voltage levels.

17. A signal processor coupled to a charger and configured to monitor and detect grid surveillance initiated by a utility company when the charger is coupled to the grid, the signal processor being configured to transfer a sequence of binary pulses into the grid via a power socket in response to a signal provided by the utility company.

18. The signal processor of claim 17, wherein the sequence of binary pulses enables a utility company to determine the location of the signal processor within the grid.

19. The signal processor of claim 17, wherein the signal processor is coupled to a telemetric device and is configured to transfer data supplied by the telemetric unit to the utility company via the sequence of binary pulses.

20. A system for determining location of a transportation means, the system comprising:
a telemetric unit coupled to the transportation means and configured to triangulate the location of transportation means by utilizing global positioning system, global system for mobile communication network and radio signals, wherein the telemetric unit is further configured to use acquired location from each of the global positioning system, global system for mobile communication network and radio signals to determine the location of the transportation means.

21. The system of claim 20, wherein the telemetric unit further utilizes wide area augmentation system (WAAS) in pinpointing the location of the transportation means.

22. The system of claim 20, wherein the telemetric unit is configured to use each of the global system for mobile communication network and radio signals for determining the location of the transportation means when global positioning system is not available.

23. A method for determining location of a transportation means in a power grid, the method comprising:
determining the location of the transportation means using a satellite global positioning system,
determining the location of the transportation means using global system for mobile communication networks; and
determining the location of the transportation means using radio signals, wherein acquired locations using satellite global positioning system, global system for mobile communication networks and radio signals are compared and the location of the transportation means is calculated with improved accuracy.

24. A system for monitoring and billing of owners of vehicle adapted to connect to a power grid and provide regulation up or down, the system comprising:
a telemetric unit coupled to the vehicle and configured to wirelessly transmit the location of the vehicle and amount of power received from the power grid or supplied to the power grid to a billing and provisioning center which in response charges or credits the vehicle owner's account or the owner of the socket to which the vehicle is connected.

25. A safety system for use in vehicles adapted to connect to the power grid for supplying power to the power grid or receiving power from the power grid, the safety system comprising:
a telemetric unit coupled to the vehicle and configured to receive a wireless command, wherein upon receiving the wireless command, the telemetric unit commands a charger coupled to the vehicle to stop receiving charge from or supply charge to the power grid.

26. The system of claim 25 wherein the wireless command is provided via a low frequency radio signal.

27. A video recording and transmission system for use in vehicles, the system comprising:
a plurality of video cameras coupled to a vehicle and positioned so as to capture video footage of external perimeter and internal space of the vehicle; and
a telemetric unit coupled to the plurality of video cameras and configured to archive the recording from each of the video cameras for a predetermined amount of time and wirelessly transmit the recorded video to a third party at specific time interval or upon request.
